(19) United States
(12) Patent Application Publication
(10) Pub. No.: US 2008/0060676 A1
(43) Pub. Date: Mar. 13, 2008

(54) WORKPIECE PROCESSING WITH PREHEAT

(76) Inventor: Dana Scranton, Kalispell, MT (US)

Correspondence Address: PERKINS COIE LLP/SEMITOOL, PO BOX 1208, SEATTLE, WA, 98111-1208, US

(21) Appl. No.: 11/530,703

(22) Filed: Sep. 11, 2006

(51) Int. Cl. C23G 1/00; B08B 7/00; B08B 3/00

(52) U.S. Cl. 134/2; 134/19; 134/26

(57) ABSTRACT

A method for cleaning vias, trenches, or other features on a workpiece, such as a semiconductor wafer, includes pre-heating the wafer to a desired temperature. A heated processing or cleaning fluid is then applied to the workpiece. The workpiece may be heated to a temperature higher than the temperature of the processing fluid, to increase the chemical reaction efficiency between the processing fluid and the workpiece features. The workpiece may be heated before or after being loaded into a processing chamber.

### BACKGROUND

Contact holes, vias, and other features in a workpiece, such as a semiconductor wafer, are typically cleaned by applying a fluid onto the workpiece. The fluid chemically reacts with and removes contaminants from the features. The contaminants are commonly by-products of an etching or other processes. For example, plasma etching may be used to form the vias or contact holes. During formation of these features, a polymer layer is formed on the walls of the via or contact hole to prevent damage or widening of the hole or via. Additional residue is often left behind in the process, such as by-products of the etched materials, photoresist, and the etch gas itself. As vias and contact holes become deeper and narrower, effective removal of these contaminants becomes increasingly difficult.

While cleaning fluids can effectively wet the via or contact hole, it may be difficult to quickly and effectively remove contamination from them. In some cases, chemical dispensing and rinsing steps must be used in sequence to provide a sufficient exchange of cleaning fluid to and from the via. Temperature is also an important variable in the wafer cleaning process. Many cleaning fluids react more effectively at higher temperatures, typically ranging from about 35 to 90° C. When the fluid is first delivered to the wafer, however, it is generally cooled by the wafer, which is typically delivered to the processing chamber at ambient temperature. As the features, such as holes or vias, tend to be deep and narrow, only very small amounts of fluid are able to penetrate into the features. Consequently, the fluid entering into the features may be cooled, via conduction of heat to the wafer, to a temperature substantially lower than the temperature of the bulk liquid on the wafer surface. This slows the reaction process, particularly in the deeper regions of the holes or vias. As a result, it can be difficult to efficiently remove contaminants from the deeper or lower regions of the vias, holes, or other features in the wafer.

It is generally desirable for the wafer cleaning process to be as short and efficient as possible. The cooling of the processing fluid slows the process. As a result, manufacturing may also be slowed down and multiple cleaning and rinsing steps may be required. Thus, a need exists for improved methods and apparatus for cleaning contaminants from vias, holes, or other features on wafers or other workpieces.

### SUMMARY

A method for cleaning vias, trenches, or other features on a workpiece, such as a semiconductor wafer, includes heating the wafer to a desired temperature before applying a heated processing or cleaning fluid to the workpiece. The workpiece is optionally heated to a temperature equal to or greater than that of the temperature of the heated processing fluid in order to increase the chemical reaction between the processing fluid and the workpiece features. The workpiece may be heated before or after being loaded into the processing chamber in which the processing fluid is applied to the workpiece.

Other features and advantages will appear hereinafter. The features described above can be used separately or together, or in various combinations of one or more of them. Sub-combinations of the features described are also contemplated. Many of the method steps described herein may be performed in an order different than that which is explicitly described.

### BRIEF DESCRIPTION OF THE DRAWINGS

In the drawings, wherein the same reference number indicates the same element throughout the separate views:

FIG. 1 is a schematic diagram of a processing chamber according to one embodiment.

FIG. 2 is a partial side-sectional view of a wafer including vias in a surface of the wafer, according to one embodiment.

### DETAILED DESCRIPTION OF THE DRAWINGS

Various embodiments of the invention will now be described. The following description provides specific details for a thorough understanding and enabling description of these embodiments. One skilled in the art will understand, however, that the invention may be practiced without many of these details.

It has now been discovered that when a heated processing or cleaning fluid is applied to a semiconductor wafer or other workpiece for removing contaminants from features in the workpiece, the most substantial cleaning typically takes place in the first few seconds after the fluid contacts the features in or on the wafer. The heated processing fluid tends to quickly lose heat to the cooler workpiece. Consequently, after the first few seconds of contact, the fluid cools considerably, before a thermal recovery takes place, and processing reactions correspondingly slow down and become less effective.

It is desirable therefore to maintain the processing fluid at a high temperature to increase the efficiency of the cleaning process. To this end, a wafer or other workpiece may be pre-heated to a desired temperature before applying the processing fluid to the workpiece. Thus, when the processing fluid reacts with the features in the heated workpiece, it can remain at a high temperature for a longer time. As a result, the processing fluid reacts more efficiently with the contaminants to be removed from the wafer features. This allows for faster cleaning cycles and reduces (or eliminates) the number of times a rinsing process must be introduced between cleaning steps.

It is typically difficult to efficiently remove the reacted processing fluid and replace it with fresh fluid at or near the bottom of a deep via or contact hole. Thus, it is especially desirable to increase the efficiency of the first few seconds of the cleaning process to reduce or eliminate the need for multiple cleaning steps and rinsing steps.

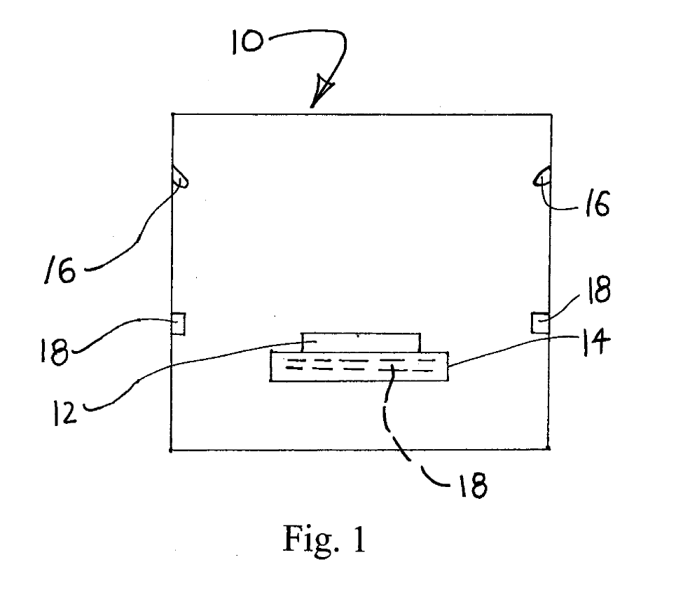

FIG. 1 illustrates one embodiment of a processing chamber 10 or other vessel in which a semiconductor wafer 12 or other workpiece may be cleaned or otherwise processed. While the term “wafer” will be used from this point forward, the processes described herein may be applied to any workpiece including features requiring contaminant removal or other cleansing.

The wafer 12 is supported on or secured to a workpiece holder 14, such as a rotor or chuck, a stationary stage, or other rotatable or fixed support. Depending on the processes to be performed, the processing chamber 10 may include nozzles 16 or other openings for delivering liquid or gas to the wafer 12, heating elements 18 for heating the wafer 12, transducers for delivering sonic energy to the wafer 12, UV or IR lamps or other process elements.

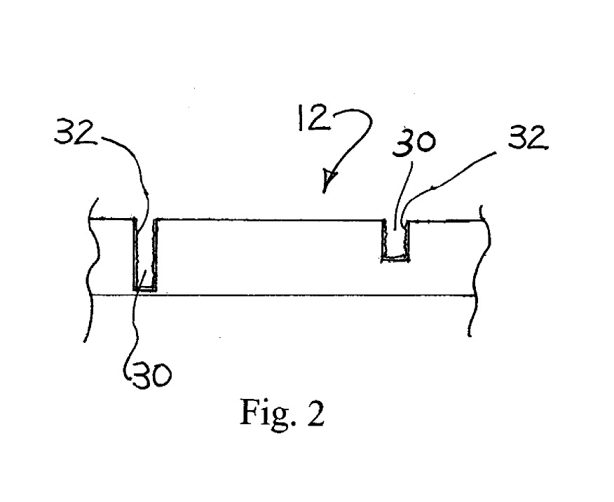

Referring to FIG. 2, the wafer 12 may have been previously etched, such as with plasma etching or a similar process. Generally, vias 30, contact holes, trenches, or other openings or features are formed on, in, or through the wafer 12. A polymer layer 32, contaminants, or other residue remaining from the etching or other process may be present along the bottom and/or side walls of the vias 30.

In a first embodiment, the wafer 12 is loaded into the processing chamber 10 and secured to the workpiece holder 14 via a robot or by hand. The robot, if used, may have a heated end effector. Heat is then applied to one or both sides of the wafer 12 via one or more heating elements 18. The heating elements 18 may be located anywhere within the processing chamber 10, including on or in the workpiece holder 14. The heating elements 18 may include infrared (“IR”) lamps, a hot plate, or other heater in or on the workpiece holder 14. Heated liquid, such as deionized water, may be sprayed, jetted or otherwise applied in bulk onto the wafer 12 to heat one or both of the upper and lower wafer surfaces.

The wafer 12 may be heated to a temperature at or near the temperature of the processing fluid that will be used to clean the wafer 12. The wafer 12 and the processing fluid may be heated to any temperature(s) suitable for a given processing application. Many processing fluids or chemicals work well at temperatures in the range of 35 to 99° C. (or higher), or 50 to 70° C., or greater than 50° C. Thus, the wafer 12 may be heated to approximately the same or a higher temperature than the processing fluid used for a given processing application.

Once the wafer 12 reaches the desired temperature, the processing fluid is sprayed or otherwise applied onto the wafer 12 from the nozzles 16 (or other openings) in the processing chamber 10. The processing fluid is preferably a liquid, but may be a vapor or a gas. Any suitable processing fluid, cleaning fluid, or chemical mixture, particularly those that are most reactive at elevated temperatures, may be used to clean the vias 30, trenches, or other features on the wafer 12.

With the wafer 12 pre-heated, the chemical reactions between the processing fluid and the polymer layer 32 or contaminants in the vias 30 occur at a high temperature. Accordingly, as the processing fluid moves into the lower regions of the vias 30, it remains at a higher temperature and reacts efficiently with contaminants in the lower regions. As a result, contaminants are removed from the lower regions of the vias 30 as effectively, or substantially as effectively, as from the upper regions of the vias 30.

After application of the processing fluid, the wafer 12 may be rinsed with deionized water or another suitable cleansing fluid to flush any loose contaminants out of the vias 30 or other features in the wafer surface. If contaminants are still present after the wafer 12 is rinsed, additional processing fluid may be sprayed or otherwise delivered to the wafer 12 to effectively remove any remaining contaminants. Processing and rinsing steps may be alternated until a desired level of cleanliness is achieved. As the wafer 12 is heated before application of the processing fluid, the efficiency of the chemical reactions is improved, and only one processing step may be required.

In an alternative embodiment, one or both sides of the wafer 12 may be heated before the wafer 12 is loaded into the processing chamber 12. The wafer 12 may be heated in an oven, on a hot plate, or in or on another suitable heating device. The wafer 12 is preferably heated to a temperature higher than the processing fluid, to compensate for the cooling of the wafer during transport of the wafer 12 from the heating device into the processing chamber 10. The wafer 12 may, for example, be heated to a temperature that is 5 to 10° C. higher than the processing fluid. After the pre-heated wafer 12 is loaded into the processing chamber 10, the heated processing fluid is sprayed or otherwise delivered onto the wafer 12 to clean the vias 30, trenches, or other features on or in the wafer 12. After application of the processing fluid, the wafer 12 may be rinsed with deionized water or another suitable cleaning fluid to flush any loose contaminants out of the vias 30 or other features in the wafer surface.

Heat may continuously be applied to the wafer 12 throughout some or all of the cleaning process, to keep the wafer 12 at a desired elevated temperature. Heat may, for example, be provided to the wafer 12 via heating elements on the workpiece holder 14 while the processing fluid is delivered to the wafer 12. Alternatively, heating elements 18 on the walls, base, or top of the processing chamber 10 may continuously provide heat to the wafer 12 during delivery of the processing fluid to the wafer 12.

If, after the wafer 12 is rinsed, the application of additional processing fluid is required to remove any remaining contaminants, the wafer 12 may optionally be re-heated to a temperature substantially equal to or greater than the processing fluid to be applied. In this embodiment, the workpiece holder 14 or the interior of the processing chamber 12 may include heating elements for heating the wafer 12 while it is secured to the workpiece holder 14. Thus, after the rinsing step is completed, the wafer 12 may be re-heated before application of additional processing fluid in order to promote increased reaction kinetics. The methods described here may be performed in combination with ozone processes, as described in U.S. Patent Publication No. 2002/0157686, incorporated herein by reference.

The processes described above may also be used in batch wafer processing in which multiple wafers are simultaneously cleaned or processed. A batch of wafers secured in a wafer tray or other workpiece holder may be pre-heated in the processing chamber or in a separate external heating device. Once the heated batch of wafers is at the desired temperature and secured within the processing chamber, heated processing fluid may be sprayed or otherwise delivered onto the batch of wafers to clean the vias 30, trenches, or other features on or in the wafers. In single or batch processing, a heated wafer holding storage location or buffer may be used to reduce process times. Features described as in the workpiece may also be on the workpiece, and vice versa.

The words used here are intended to be interpreted in their broadest reasonable manner, even though they are used with a detailed description of certain specific embodiments of the invention. Any words intended to be interpreted in any restricted way, however, will be specifically defined in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

While several embodiments have been shown and described, various changes and substitutions may of course be made, without departing from the spirit and scope of the invention. Many of the method steps described herein, for example, may be performed in a different order than that which is explicitly described. Moreover, many of the embodiments described herein may be used separately or in combination with one or more additional embodiments. The invention, therefore, should not be limited, except by any claims and their equivalents.

1. A method for cleaning a wafer, comprising:
providing a processing fluid at a first temperature;
heating the wafer to a second temperature equal to or higher than the first temperature, at least in part via conduction of heat to the wafer from a surface supporting the wafer; and
delivering the processing fluid to a surface of the heated wafer to remove contaminants from vias, trenches, or holes in the surface of the wafer;
wherein the second temperature is high enough to maintain the wafer at a temperature at least as high as the first temperature at the time the processing fluid is delivered onto a surface of the heated wafer.

2. (canceled)

3. The method of claim 2 wherein the wafer is heated to the second temperature before the wafer is loaded into the processing chamber.

4. The method of claim 2 wherein the wafer is loaded into the processing chamber before the wafer is heated to the second temperature.

5. (canceled)

6. The method of claim 1 wherein the first temperature is greater than 50° C.

7. The method of claim 1 wherein the second temperature is at least 5° C. higher than the first temperature.

8. (canceled)

9. The method of claim 1 further comprising continuously applying heat to the wafer for at least a part of the time that the processing fluid is delivered to the wafer.

10. The method of claim 1 further comprising:
stopping delivery of the processing fluid to the wafer;
rinsing the surface of the wafer;
re-heating the wafer to a third temperature that is at least as high as the first temperature; and
delivering additional processing fluid to the surface of the wafer.

11. The method of claim 1 wherein the processing fluid is delivered to an upper surface and a lower surface of the wafer.

12. The method of claim 1 wherein an upper surface and a lower surface of the wafer are heated before the processing fluid is delivered to the wafer.

13. A method for cleaning features in a surface of a workpiece using a heated cleaning fluid, comprising:
loading the workpiece into a processing chamber;
delivering a cleaning fluid at a first temperature to the surface of the workpiece to remove contaminants from vias, trenches, and/or contact holes the features in the surface of the workpiece;
heating the workpiece to a second temperature higher than the first temperature, before applying the cleaning fluid; and
continuing to apply heat to the workpiece for at least a portion of the time that the cleaning fluid is delivered to the workpiece.

14-15. (canceled)

16. The method of claim 13 wherein the cleaning fluid includes deionized water.

17. The method of claim 13 further comprising:
stopping delivery of the cleaning fluid to the workpiece;
rinsing the surface of the workpiece;
re-heating the workpiece to a temperature that is at least as high as the temperature of the cleaning fluid; and
delivering additional cleaning fluid to the surface of the workpiece.

18. A method for cleaning features in a surface of a workpiece with a heated cleaning fluid, comprising:
heating the workpiece to a temperature that is at least 5° C. higher than the temperature of the cleaning fluid;
loading the heated workpiece into a processing chamber; and
applying the heated cleaning fluid to the surface of the heated workpiece to remove contaminants from the features in the surface of the workpiece; and
continuing to heat the workpiece via a conductive heating element contacting the workpiece or via a radiant heater, after applying the cleaning fluid to the workpiece.

19-20. (canceled)

21. The method of claim 18 wherein an upper surface and a lower surface of the workpiece are heated before the workpiece is loaded into the processing chamber.
